(19) United States
(12) Patent Application Publication
(10) Pub. No.: US 2012/0208635 A1
(43) Pub. Date: Aug. 16, 2012

(54) METHOD AND GAMING DEVICE FOR CONTROLLING USE OF ONE OR MORE PERIPHERAL DEVICES

(75) Inventor: Richard Paul Hayes, Malabar (AU)

(73) Assignee: ARISTOCRAT TECHNOLOGIES AUSTRALIA PTY LIMITED, North Ryde (AU)

(21) Appl. No.: 13/455,621

(22) Filed: Apr. 25, 2012

Related U.S. Application Data
(63) Continuation of application No. 12/606,748, filed on Oct. 27, 2009.

(30) Foreign Application Priority Data
Nov. 3, 2008 (AU) 2008905673

(51) Int. Cl. G06F 17/00

(52) U.S. Cl. 463/29

(57) ABSTRACT

A method of controlling use of one or more peripheral devices with an electronic gaming device, the method including: determining whether at least one peripheral device is authorised for operation with the electronic gaming device by determining whether there is a dongle fitted to the electronic gaming device containing an authorisation of the at least one peripheral device; and at least partially disabling the operation of any peripheral device for which it is determined that there is not a dongle fitted to the electronic gaming device containing an authorisation of the peripheral device.

### CROSS-REFERENCE TO RELATED APPLICATIONS

The present application claims the benefit of priority to U.S. patent application Ser. No. 12/606,748, filed on Oct. 27, 2009, entitled “METHOD AND GAMING DEVICE FOR CONTROLLING USE OF ONE OR MORE PERIPHERAL DEVICES”, and Australian Provisional Patent Application No. 2008905673, filed on Nov. 3, 2008, entitled “A METHOD AND GAMING DEVICE FOR CONTROLLING USE OF ONE OR MORE PERIPHERAL DEVICES”, which are herein incorporated by reference in their entirety.

### FIELD

This invention related to a method and gaming device for controlling use of one or more peripheral devices.

### BACKGROUND

In the gaming industry, where possible, modular design is used such that gaming machines are deployed by manufacturers on a small number of modular gaming platforms—i.e. the physical apparatus on which game program code will run.

Accordingly, a significant amount of money is invested in the development of the gaming platform. Such a gaming platform needs to be compatible with a number of peripherals including bill validators, ticket printers and the like. Problems can arise when unauthorized peripherals are attached to gaming machines.

Accordingly, we have determined that there is a need to control the attachment of peripherals to the gaming platform.

### SUMMARY

In a first aspect, the invention provides a method of controlling use of one or more peripheral devices with an electronic gaming device, the method including:
determining whether at least one peripheral device is authorised for operation with the electronic gaming device by determining whether there is a dongle fitted to the electronic gaming device containing an authorisation of the at least one peripheral device; and
at least partially disabling the operation of any peripheral device for which it is determined that there is not a dongle fitted to the electronic gaming device containing an authorisation of the peripheral device.

In an embodiment, the method includes at least partially disabling operation by disabling the peripheral device.

In an embodiment, the method includes at least partially disabling operation by preventing or disrupting communication of the peripheral device with at least one other gaming device component.

In an embodiment, the method includes determining whether the dongle is valid.

In an embodiment, determining whether the dongle is valid includes:
obtaining from the dongle a dongle public key and a dongle signature of the dongle public key encrypted with a master private key;
decrypting the dongle signature with a master public key; and
determining based on a comparison of the decrypted dongle signature with the dongle public key whether the dongle is valid.

In an embodiment, the method includes determining whether the authorisation is valid.

In an embodiment, determining whether an authorisation exists for a peripheral device includes determining whether an authorisation exists for the type or class of peripheral.

In an embodiment, the dongle is a smart card.

In an embodiment, the method includes determining whether a plurality of peripheral devices are valid.

In an embodiment, the method includes checking a plurality of dongles.

In an embodiment, at least one peripheral performs a plurality of functions and partially disabling operation of the peripheral device involves preventing at least one function from being implemented while allowing another function to be implemented.

In a second aspect, the invention provides an electronic gaming device including:
a main circuit in data communication with one or more peripheral devices, the main circuit arranged to:
   determine whether at least one peripheral device is authorised for operation with the electronic gaming device by determining whether there is a dongle in data communication with the main circuit containing an authorisation of the at least one peripheral device; and
   at least partially disable the operation of any peripheral device for which it is determined that there is not a dongle fitted to the electronic gaming device containing an authorisation of the peripheral device.

In an embodiment, the main circuit is adapted to have a plurality of dongles connected thereto whereby peripheral devices can be authorised independently.

In an embodiment, the main circuit at least partially disables operation by disabling the peripheral device.

In an embodiment, the main circuit at least partially disables operation by preventing or disrupting communication of the peripheral device with at least one other gaming device component.

In an embodiment, the main circuit is arranged to determine whether the dongle is valid.

In an embodiment, in order to determine whether the dongle is valid, the main circuit:
obtains from the dongle a dongle public key and a dongle signature of the dongle public key encrypted with a master private key;
decrypts the dongle signature with a master public key; and determines based on a comparison of the decrypted dongle signature with the dongle public key whether the dongle is valid.

In an embodiment, the main circuit determines whether the authorisation is valid.

In an embodiment, the main circuit determines whether an authorisation exists for a peripheral device by determining whether an authorisation exists for the type or class of peripheral.

In an embodiment, the dongle is a smart card.

In an embodiment, at least one peripheral performs a plurality of functions and the main circuit partially disables operation of the peripheral device by preventing at least one function from being implemented while allowing another function to be implemented.

In a third aspect, the invention provides a method of controlling use of peripheral devices with an electronic gaming device including:
providing at least one port to which at least one gaming peripheral devices can be connected; and
requiring an operator of the electronic gaming device to fit to the gaming device one or more dongles containing an authorisation for at least one connected peripheral device in order to enable the peripheral device to function fully with the gaming device.

In an embodiment, the method includes requiring the operator to fit to the gaming device one or more dongles containing authorisations for each peripheral device.

In a fourth aspect, the invention provides computer program code which when executed implements the method of the first aspect.

In a fifth aspect, the invention provides a tangible computer readable medium including the computer program code.

In a sixth aspect, the invention provides for transmitting the program code.

### BRIEF DESCRIPTION OF THE DRAWINGS

Certain embodiments of the invention will be described, by way of example, in relation to the accompanying drawings, in which:

FIG. 1 is an isometric view of a gaming machine;

FIG. 2 is a block diagram of a gaming machine;

FIG. 3 is a flow diagram; and

FIG. 4 is a block diagram of a Smartcard.

Features, further aspects, and advantages of the present invention will become apparent from the following description of embodiments thereof, by way of example only, with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended apparatus claims are read to cover a purely software and/or firmware implementation, in at least one embodiment, at least one of the elements is hereby expressly defined to include a tangible medium such as a memory, DVD, CD, etc. storing the software and/or firmware.

Referring to the drawings, there is shown a gaming device which provides a gaming platform which is configured to support a number of peripherals such as displays, input devices (e.g. buttons or a touch screen), bill valuators, ticket printers etc. Some of these peripherals form part of base funcitionality whereas others are provided to provide extended functionality. The embodiment employs authorisation of one or more peripherals based on tokens stored on a dongle (that is, an electronic device that must be in data communication with part of the gaming device (e.g. the main circuit board) if the relevant peripheral device is to operate or operate with full functionality). In the embodiment, the dongle takes the form of a Smartcard. In an embodiment, the main circuit board of the electronic gaming device is adapted to receive a plurality of dongles and only one token for an individual peripheral device is supplied on each dongle so that a dongle for each peripheral device must be attached.

The embodiment can be employed for a number of different reasons. One reason for employing dongles is so that only compatible and/or authorised peripherals can be used with the gaming device. In particular, because of the nature of the commercial and regulatory environment, it is important that gaming machines do not fail—for example, in a manner which affects the return to a player or enables undesired access to the gaming machine or gaming network.

Accordingly, in one embodiment, a dongle may contain a token (and hence authorisation) for one or more compatible and/or authorised gaming peripheral devices. Another reason for using dongles is so that the supplier of the gaming device can the control the use of functionality provided by the gaming device. For example, the main circuit board may provide ticket-in ticket-out (TITO) functionality if a ticket printer and a ticket reader are connected, and the gaming device supplier may which to ensure that third party or after market TITO devices are not fitted to the gaming machine unless supplied or authorised by the supplier. For example, a dongle may be used so that any third party suppliers are required to obtain a dongle containing a relevant token, thus allowing the supplier to require them to meet appropriate quality standards and/or levy a fee on the enablement of the functionality they have developed (or indeed to provide the functionality for free if this serves their commercial needs).

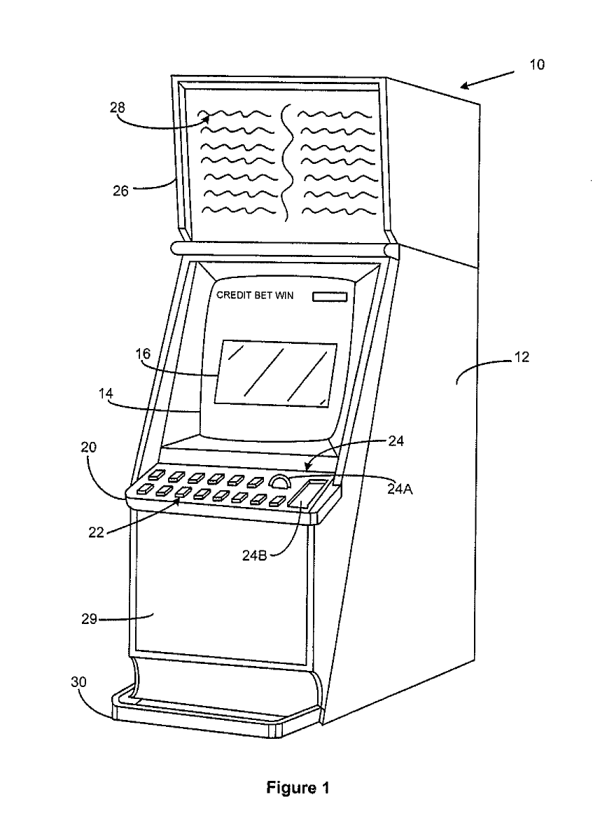

An electronic gaming device in the form of gaming machine 10 is illustrated in FIG. 1. The gaming machine 10 has a number of components which enable a player to interact with the gaming machine (e.g. to input game instructions, input/output credits, and watch the game), these are referred to collectively as a “player interface” and the components will become apparent from the following description. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 1 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

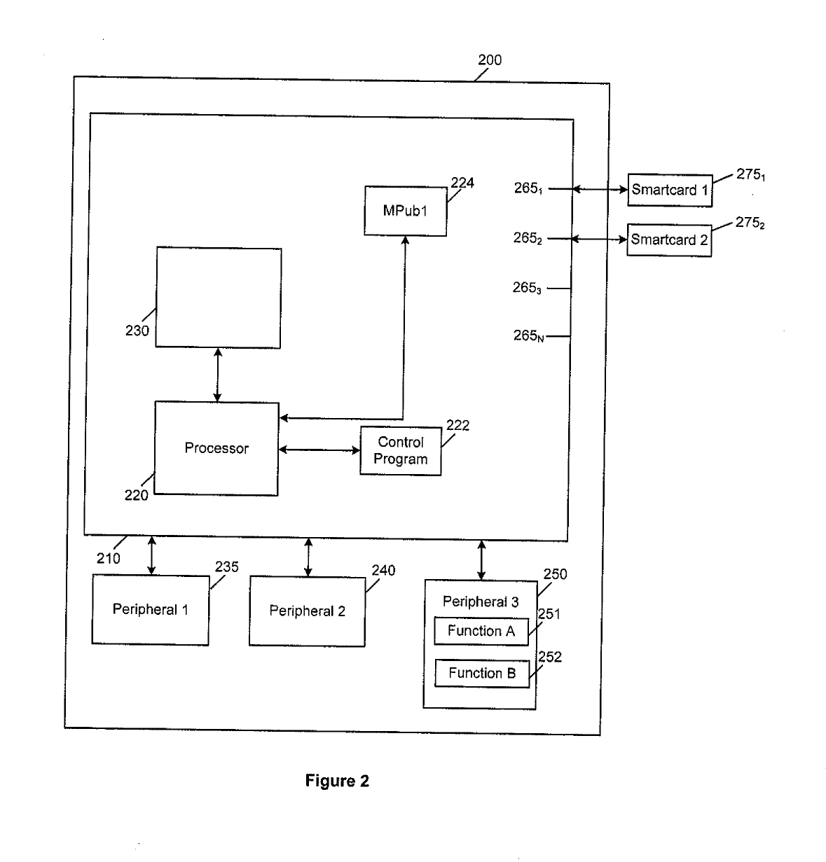

FIG. 2 is a block diagram illustrating components of a gaming device in the form of a gaming machine 200 relevant to the embodiment. Other components known to persons skilled in the art such as hardware meters are not illustrated for clarity of exposition. The gaming machine 200 has a main circuit in the form of a main circuit board 210 having a main processor 220 and a main memory 230. Herein the term “processor” is used to refer generically to any device that can process instructions and may include: a microprocessor, microcontroller, programmable logic device or other computational device.

The gaming machine has a plurality of peripheral connected to the main board 210, some of which will only operate or operate fully provided a dongle 275 having a valid token corresponding to the game is connected to the main board 220 by one of slots 265.

The main circuit board 210 contains a plurality of sockets 265₁ to 265ₙ (for example 24 sockets) each adapted to have a Smartcard 275 inserted therein to provide a dongle.

The processor 220 communicates with a control program on the Smartcard. In order execute any one of the game programs 235₁ to 235ₙ an appropriate relevant Smartcard must be attached to one of the ports 265. The main circuit includes its own control program 22, typically stored in a BIOS as part of the operating system of the gaming device and executed during a boot process.

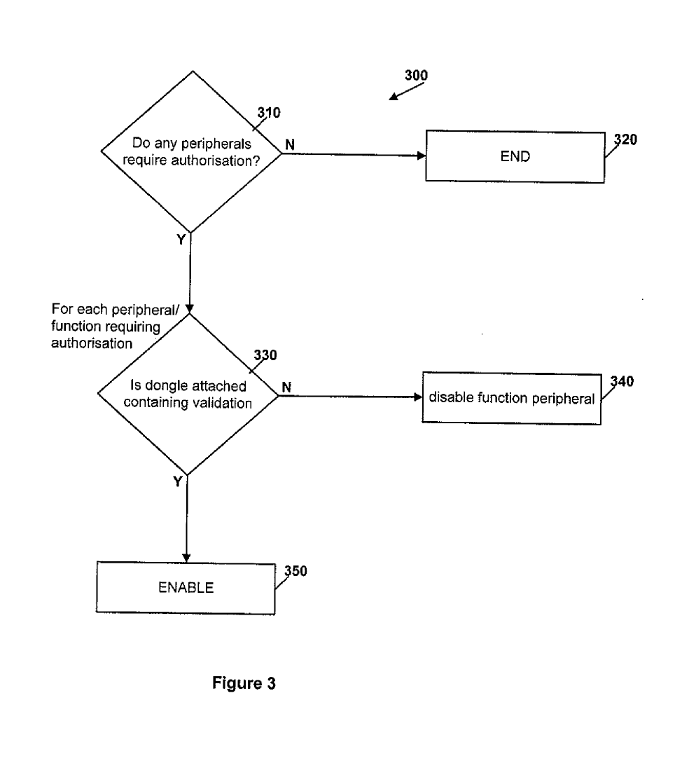

Persons skilled in the art will appreciate that the process may determine what peripherals are attached in a number of different ways such as polling ports to which peripherals may be attached. Referring to FIG. 3, once the connected peripherals have been determined, the method 300 involves determining 310 whether any peripherals require authorisation. If no peripherals require authorisation, the process ends 320. If one or more peripherals (or peripheral functions as described below) require authorisation, the method involves, for each peripheral, determining 330 whether a dongle is attached which contains a valid token. If there is not a valid token, the method involves taking an action to prevent the peripheral (or a function of the peripheral) from working to effectively disable the peripheral or part of its functionality. If the there is a valid token, the peripheral is enabled 350.

As indicated above, part of the functionality of a peripheral may be partially enabled, for example, the peripheral may be able to communicate sufficiently with the processor 220 to enable the processor to issue an error message if the peripheral is used. In another example, a peripheral may be capable of performing multiple functions but only one function may be enabled.

Referring again to FIG. 2, three peripherals 235,240,250 are shown. In one example, a first peripheral 235 may form part of the base functionality (e.g. a display) but is checked for compatibility. During the control process, processor checks the first smart card 275₁ and finds an authorisation token so the first peripheral is enabled. In contrast, second peripheral relates to extended functionality (e.g. a player tracking module) but neither smart card 275₁, 275₂ contains an authorisation token so it not enabled. Finally, third peripheral 250 capable of two functions 251,252 (e.g. a bill validator which is capable of reading currency bills and tickets for TITO). Function B 252 is not intended to be enabled and accordingly second smart card 275₂ only contains an authorisation token for function A.

It will be appreciated by persons skilled in the art that this provides advantages in configuring gaming machines. However, Smartcards 275 can be configured to carry tokens for a plurality of different peripherals. For example, a first dongle can be used for base funcitionality and additional dongles can be required for extended functionality.

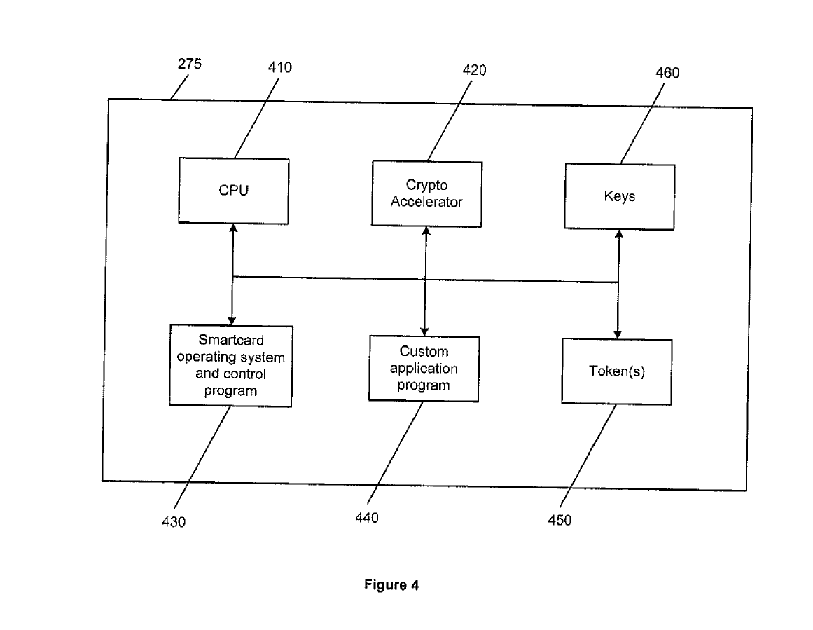

Referring to FIG. 4, each Smartcard 275 includes a CPU 410, a cryptographic accelerator 420, a Smartcard operating system control program 430, a custom application 440, a table of tokens 450 and a key and signature store 460 which stores a unique private and public key pair (e.g. RSA) hereafter referred to as “SCPubX, and SCPrivX” and a signature of SCPubX, (Signature 1) that has been generated at a previous time by encrypting an encoded SHA-1 hash of SCPubX with a private RSA master key (MPriv1) in a secure environment. The table 450 can contain one or a plurality of tokens (authorisations) depending on the embodiment.

The electronic gaming device 200 has a control program 222 and a copy of the public master key MPub1 224. This enables the gaming device to authenticate each token.

An authentication process 310 involves the Smartcard 275 being authenticated as a valid Smartcard. Each time the electronic gaming machine 200 is powered on or reset, the control program of the electronic gaming machine 222 begins execution. At some time before the electronic gaming device allows the peripherals to operate, it begins communication with the Smartcard 275. At step 312, the control program 222 requests a key from the Smartcard. The Smartcard reader interface of the electronic gaming machine is configured to establish connection with the Smartcard according to ISO7816.

The electronic gaming device 200 communicates with the Smartcard and selects the custom application 440. The electronic gaming machine 200 authenticates the Smartcard as a genuine Smartcard by retrieving SCPubX from the Smartcard 275 and Signature 1 from the Smartcard and then decrypts Signature 1 with MPub1 using the relevant algorithm. The gaming device then determines whether the decrypted signature matches RSA-1 hash of SCPubX. If it does, the Smartcard is accepted as authentic if not, an invalid signed key output is generated and then the Smartcard is powered off.

The next stage in the process is a verification stage 320. In this stage, the gaming device attempts to retrieve software protection tokens for specific peripherals. The control program makes a licence request by requesting a token with a particular peripheral ID. This message is sent encrypted with the public key SCPubX of the Smartcard. The licence request is verified by decrypting the message and checking the ID against a stored value to determine if that ID is in the token. A response is which sends data from the software protection token together with a signature of the ID by signing the exchanged data with SCPrivX. The EGM 200 then verifies the signed data which then allows the peripheral (or function) to operate.

Persons skilled in the art will appreciate that this checking process can also be done periodically during operation of the gaming device to prevent one smart card being used to boot plural gaming devices.

Suitable methods of public key encryption/authentication are described in U.S. Pat. Nos. 5,643,086 (Alcorn) and 6,722,986 (Lyons et al.), which are incorporated herein by reference.

Persons skilled in the art will appreciate that in some embodiments, the smart card need not be connected directly to the gaming device for example, gaming device might be connected to a server through a network and the server include provision for attaching smart card tied to specific gaming devices.

Further aspects of the method will be apparent from the above description of the gaming system. Persons skilled in the art will also appreciate that parts of the method could be embodied in program code. The program code could be supplied in a number of ways, for example on a tangible computer readable medium, such as a disc or a memory (for example, that could replace part of memory 103) or as a data signal (for example, by downloading it from a server).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A method of controlling use of a gaming machine peripheral device that is arranged to perform a plurality of different functions, the method comprising:
determining whether the peripheral device is authorised for operation with an electronic gaming machine by determining whether there is a dongle, containing an authorisation token, installed in fitted to the electronic gaming machine; and
selectively enabling or disabling each of the plurality of different functions based on an outcome of an authentication process involving the authorisation token.

2. A method as claimed in claim 1 comprising at least partially disabling operation by disabling the peripheral device.

3. A method as claimed in claim 1 comprising at least partially disabling operation by preventing or disrupting communication of the peripheral device with at least one other gaming machine component.

4. A method as claimed in claim 1 further comprising determining whether the dongle is valid.

5. A method as claimed in claim 4, wherein determining whether the dongle is valid comprises:
obtaining from the dongle a dongle public key and a dongle signature of the dongle public key encrypted with a master private key;
decrypting the dongle signature with a master public key; and
determining based on a comparison of the decrypted dongle signature with the dongle public key whether the dongle is valid.

6. A method as claimed in claim 1, comprising determining whether the authorisation is valid.

7. A method as claimed in claim in claim 1 wherein determining whether an authorisation exists for a peripheral device comprises determining whether an authorisation exists for the type or class of peripheral.

8. A method as claimed in claim 1 wherein the dongle is a smart card.

9. A method as claimed in claim 1 comprising determining whether a plurality of peripheral devices are valid.

10. A method as claimed in claim 9 comprising checking a plurality of dongles.

11. A method as claimed in claim 1, wherein at least one peripheral performs a plurality of functions and partially disabling operation of the peripheral device involve preventing at least one function from being implemented while allowing another function to be implemented.

12. An electronic gaming machine comprising:
a main circuit in data communication with a gaming machine peripheral device that is arranged to perform a plurality of different functions, the main circuit arranged to:
determine whether the peripheral device is authorised for operation with an electronic gaming machine by determining whether there is a dongle, containing an authorisation token, installed in the electronic gaming machine and in data communication with the main circuit and
selectively enabling or disabling each of the plurality of different functions based on an outcome of an authentication process involving the authorisation token.

13. An electronic gaming machine as claimed in claim 12 wherein the main circuit is adapted to have a plurality of dongles connected thereto whereby peripheral devices can be authorised independently.

14. An electronic gaming machine as claimed in claim 12, wherein the main circuit at least partially disables operation by disabling the peripheral device.

15. An electronic gaming machine as claimed in claim 12, wherein the main circuit at least partially disables operation by preventing or disrupting communication of the peripheral device with at least one other gaming machine component.

16. An electronic gaming machine as claimed in claim 12, wherein the main circuit is arranged to determine whether the dongle is valid.

17. An electronic gaming machine as claimed in claim 4, wherein, in order to determine whether the dongle is valid, the main circuit:
obtains from the dongle a dongle public key and a dongle signature of the dongle public key encrypted with a master private key;
decrypts the dongle signature with a master public key; and
determines based on a comparison of the decrypted dongle signature with the dongle public key whether the dongle is valid.

18. An electronic gaming machine e as claimed in claim 12, wherein the main circuit determines whether the authorisation is valid.

19. An electronic gaming machine as claimed in claim 12, wherein the main circuit determines whether an authorisation exists for a peripheral device by determining whether an authorisation exists for the type or class of peripheral.

20. An electronic gaming machine as claimed in claim 12 wherein the dongle is a smart card.

21. An electronic gaming machine as claimed in claim 12, wherein at least one peripheral performs a plurality of functions and the main circuit partially disables operation of the peripheral device by preventing at least one function from being implemented while allowing another function to be implemented.

22. A method of controlling use of peripheral devices with an electronic gaming machine comprising:
providing at least one port to which a gaming machine peripheral device that is arranged to perform a plurality of different functions is to be connected; and
accepting required user input including an operator of the electronic gaming machine to install a dongle in the electronic gaming machine, containing an authorisation token selectively enabling or disabling each of the plurality of different functions based on an outcome of an authentication process involving the authorisation token, for the connected gaming machine peripheral device in order to enable the gaming machine peripheral device to function with the gaming machine.

23. A method as claimed in claim 13 comprising requiring the operator to fit to the gaming device machine one or more dongles containing authorisations for each peripheral device.

24. A tangible computer readable storage medium comprising computer program code which when executed by a processor implements a method of controlling use of a gaming machine peripheral device that is arranged to perform a plurality of different functions, the method comprising:
determining whether the peripheral device is authorised for operation with an electronic gaming machine by determining whether there is a dongle, containing an authorisation token, installed in fitted to the electronic gaming machine; and
selectively enabling or disabling each of the plurality of different functions based on an outcome of an authentication process involving the authorisation token.
